(19) United States
(12) Patent Application Publication
(10) Pub. No.: US 2026/0313496 A1
(43) Pub. Date: Oct. 8, 2026

(54) LAYER 1/2 TRIGGERED MOBILITY OPERATION

(71) Applicant: NOKIA TECHNOLOGIES OY, Espoo (FI)

(72) Inventors: Mihai ENESCU, Espoo (FI); Sanjay GOYAL, Denville, NJ (US); Timo KOSKELA, Oulu (FI)

(21) Appl. No.: 19/169,971

(22) Filed: Apr. 3, 2025

(51) Int. Cl. H04W 36/08; H04B 7/06; H04W 76/30

(52) U.S. Cl. CPC H04W 36/08; H04B 7/0626; H04W 76/30

(57) ABSTRACT

Systems, methods, apparatuses, and computer program products for a layer triggered mobility operation. A method may include determining channel state information for a serving cell and channel state information for a candidate cell. The method may also include transmitting, to a network element, a report comprising the channel state information of the serving cell and the channel state information of the candidate cell. The method may further include receiving, in response to transmitting the report, a channel switch command from the network element. In addition, the method may include determining whether an event is triggered based on an evaluation of the channel state information of the serving cell and the channel state information of the candidate cell. Further, the method may include releasing, in response to determining that an event is triggered, channel state information processing units allocated for the determination of the channel state information for the serving cell.

### FIELD

Some example embodiments may generally relate to mobile or wireless telecommunication systems, such as Long Term Evolution (LTE) or fifth generation (5G) new radio (NR) access technology, or 5G beyond, or sixth generation (6G) access technology, or other communications systems. For example, certain example embodiments may relate to layer 1/2 triggered mobility operation.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, fifth generation (5G) radio access technology or new radio (NR) access technology and/or sixth generation (6G) radio access technology. Fifth generation (5G) and sixth generation (6G) wireless systems refer to the next generation (NG) of radio systems and network architecture. 5G and 6G network technology is mostly based on new radio (NR) technology, but the 5G/6G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Some example embodiments may be directed to a method. The method may include determining channel state information for a serving cell and channel state information for a candidate cell. The method may also include transmitting, to a network element, a report comprising the channel state information of the serving cell and the channel state information of the candidate cell. The method may further include receiving, in response to transmitting the report, a channel switch command from the network element. In addition, the method may include determining whether an event is triggered based on an evaluation of the channel state information of the serving cell and the channel state information of the candidate cell. Further, the method may include releasing, in response to determining that an event is triggered, channel state information processing units allocated for the determination of the channel state information for the serving cell.

Other example embodiments may be directed to an apparatus. The apparatus may include at least one processor, and at least one memory storing instructions which, when executed by the at least one processor, cause the apparatus to at least determine channel state information for a serving cell and channel state information for a candidate cell. The apparatus may also be caused to transmit, to a network element, a report comprising the channel state information of the serving cell and the channel state information of the candidate cell. The apparatus may further be caused to receive, in response to transmitting the report, a channel switch command from the network element. In addition, the apparatus may be caused to determine whether an event is triggered based on an evaluation of the channel state information of the serving cell and the channel state information of the candidate cell. Further, the apparatus may be caused to release, in response to determining that an event is triggered, channel state information processing units allocated for the determination of the channel state information for the serving cell.

Other example embodiments may be directed to an apparatus. The apparatus may include means for determining channel state information for a serving cell and channel state information for a candidate cell. The apparatus may also include means for transmitting, to a network element, a report comprising the channel state information of the serving cell and the channel state information of the candidate cell. The apparatus may further include means for receiving, in response to transmitting the report, a channel switch command from the network element. In addition, the apparatus may include means for determining whether an event is triggered based on an evaluation of the channel state information of the serving cell and the channel state information of the candidate cell. Further, the apparatus may include means for releasing, in response to determining that an event is triggered, channel state information processing units allocated for the determination of the channel state information for the serving cell.

In accordance with other example embodiments, a non-transitory computer readable medium may be encoded with instructions that may, when executed in hardware, perform a method. The method may include determining channel state information for a serving cell and channel state information for a candidate cell. The method may also include transmitting, to a network element, a report comprising the channel state information of the serving cell and the channel state information of the candidate cell. The method may further include receiving, in response to transmitting the report, a channel switch command from the network element. In addition, the method may include determining whether an event is triggered based on an evaluation of the channel state information of the serving cell and the channel state information of the candidate cell. Further, the method may include releasing, in response to determining that an event is triggered, channel state information processing units allocated for the determination of the channel state information for the serving cell.

Other example embodiments may be directed to a computer program product that performs a method. The method may include determining channel state information for a serving cell and channel state information for a candidate cell. The method may also include transmitting, to a network element, a report comprising the channel state information of the serving cell and the channel state information of the candidate cell. The method may further include receiving, in response to transmitting the report, a channel switch command from the network element. In addition, the method may include determining whether an event is triggered based on an evaluation of the channel state information of the serving cell and the channel state information of the candidate cell. Further, the method may include releasing, in response to determining that an event is triggered, channel state information processing units allocated for the determination of the channel state information for the serving cell.

Other example embodiments may be directed to an apparatus that may include circuitry configured to determine channel state information for a serving cell and channel state information for a candidate cell. The apparatus may also include circuitry configured to transmit, to a network element, a report comprising the channel state information of the serving cell and the channel state information of the candidate cell. The apparatus may further include circuitry configured to receive, in response to transmitting the report, a channel switch command from the network element. In addition, the apparatus may include circuitry configured to determine whether an event is triggered based on an evaluation of the channel state information of the serving cell and the channel state information of the candidate cell. Further, the apparatus may include circuitry configured to release, in response to determining that an event is triggered, channel state information processing units allocated for the determination of the channel state information for the serving cell.

### BRIEF DESCRIPTION OF THE DRAWINGS:

For proper understanding of example embodiments, reference should be made to the accompanying drawings, wherein:

FIG. 1 illustrates example procedures for channel state information (CSI) acquisition before/during a layer 1/2 triggered mobility (LTM) cell switch.

FIG. 2 illustrates an example signal diagram of an LTM procedure between a user equipment (UE) and a gNB.

FIG. 3 illustrates an example UE initiated beam management (UEIBM) timeline.

FIG. 4 illustrates an example LTM CSI event timeline, according to certain example embodiments.

FIG. 5 illustrates an example flow diagram of a method, according to certain example embodiments.

FIG. 6 illustrates an example flow diagram of another method, according to certain example embodiments.

FIG. 7 illustrates a set of apparatuses according to certain example embodiments.

FIG. 8 illustrates an example of a 5G/6G network and system architecture, according to certain example embodiments.

FIG. 9 illustrates an example 6G architecture, according to certain example embodiments.

FIG. 10 illustrates an example 6G radio access network (RAN) protocol stack, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for a layer 1/2 triggered mobility operation. Herein, “layer 1/2″ refers to layer 1 and layer 2 as defined in the 5G protocol stack. The term ”layer 1/2″ may also be represented as “L1/L2.”

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “base station”, “cell”, “node”, “gNB”, “network” or other similar language throughout this specification may be used interchangeably. As also described throughout this specification, “candidate cell” and “target cell”, or other similar language may be used interchangeably. Additionally, “source cell” and “serving cell”, or other similar language may be used interchangeably throughout this specification.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

The specifications of the 3^{rd} Generation Partnership Project (3GPP) provide for R19 mobility enhancements such as, for example, enhancements to layer 1/2 triggered mobility (LTM) with channel state information reference signal (CSI-RS) measurements where CSI acquisition is enabled. The CSI acquisition may be performed on a candidate cell(s) based on CSI-RS objectives, and the CSI may include channel information such as, for example, channel quality indicator (CQI), rank indicator (RI), and/or precoding matrix indicator (PMI). With the CSI information, it may be possible for a user equipment (UE) to acquire and report CSI parameters (e.g., CQI, PMI, RI, and/or LI) for a candidate cell (e.g., target cell), which can then be used for transmission/reception in the target cell after a cell switch. By having these capabilities, it may be possible to reduce the need of additional measurements for CSI acquisition in the target cell for initial transmissions/receptions. As such, the specifications of 3GPP disclose CSI acquisition on a candidate cell(s) based on CSI-RS before or during LTM cell switch, and disclose determining whether to support CSI reporting before or during the LTM cell switch, as part of the CSI acquisition procedure.

LTM is a cell switch procedure where the UE's serving cell (e.g., primary cell (PCell) or primary secondary cell (PSCell)) is switched by the network (NW) by transmitting a LTM cell switch command (CSC). A CSC may be delivered by medium access control (MAC) signaling using a MAC control element (CE), and is not delivered via radio resource control (RRC) signaling as a L3-based handover (HO).

In certain scenarios, a LTM cell switch decision may be based on measurements (e.g., L1 measurements) that are performed and reported (e.g., L1 measurement report) by the UE. Measurements and reporting may be based on LTM candidate cell configurations provided by the NW for one or more LTM candidate cells. An LTM candidate cell may be a neighboring cell or a UE's current serving cell (e.g., a current secondary cell). Additionally, LTM measurements on a neighboring candidate cell may be performed using synchronization signal blocks (SSBs) transmitted by the candidate cell for which the SSB configuration is provided to the UE.

Before the cell switch in LTM, the NW may activate one or more transmission configuration indicator (TCI) states for one or more candidate cells for early downlink (DL) synchronization. Once a candidate cell TCI state is activated, the UE may begin tracking the DL time/frequency synchronization using reference signals associated with the activated TCI state(s). The UE may also perform early UL synchronization before the cell switch if early UL synchronization is requested by the NW.

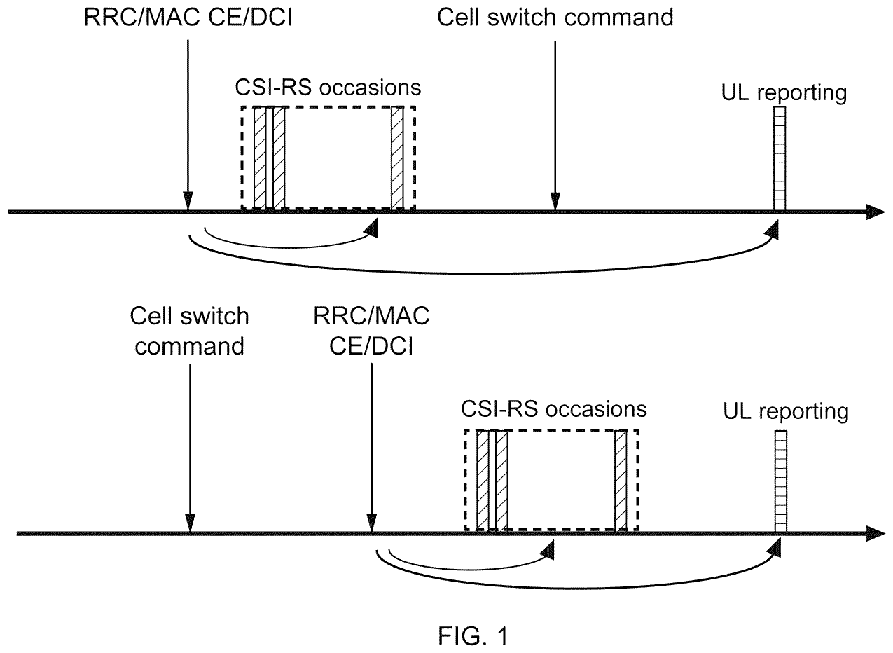

FIG. 1 illustrates example procedures for CSI acquisition before/during LTM cell switch. 3GPP provides various solutions of CSI acquisition related measurements and reporting. As one example, CSI-RS measurement and CSI reporting operations may be performed before reception of an LTM cell switch command (CSC) MAC CE. In this example, the report may be sent to the serving cell and transferred from the serving cell to the candidate/target cell(s).

In another example illustrated in FIG. 1, the CSI-RS measurement may begin before reception of the LTM CSC Mac CE, and CSI reporting operation may be performed after reception of the LTM CSC MAC CE. In this example, the report may be transmitted directly to the target cell.

In a further example illustrated in FIG. 1, the CSI-RS measurement and CSI reporting operations may both be performed after reception of the LTM CSC MAC CE. In this example, the CSI-RS measurement and CSI reports may be transmitted directly to the target cell.

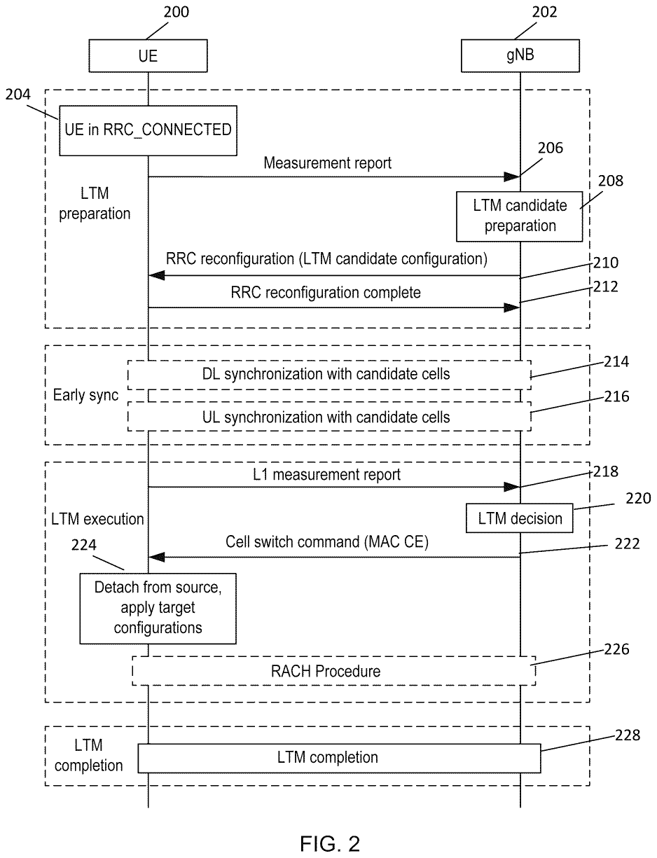

FIG. 2 illustrates an example signal diagram of a LTM procedure between a UE 200 and gNB 202. At 204, the UE 200 is in RRC CONNECTED state with the gNB 202. At 206, the UE 200 transmits a measurement report message to the gNB 202. At 208, the gNB 202 determines to configure LTM and initiate LTM preparation for the UE 200. At 210, the gNB 202 transmits an RRCReconfiguration message to the UE 200 including the LTM candidate configurations. Once received, the UE 200 stores the LTM candidate configurations, and at 212, transmits an RRCReconfigurationComplete message to the gNB 202 confirming receipt of the RRCReconfiguration message.

At 214, the UE 200 performs DL synchronization (e.g., via early TCI activation) with the candidate cell(s) before receiving a CSC from the gNB 201. At 216, the UE 200 performs early timing advance (TA) acquisition with the candidate cell(s) as requested by the NW before receiving CSC. Early TA acquisition may be performed via contention-free random access (CFRA) triggered by a physical downlink control channel (PDCCH) order from the source cell. After CFRA, the UE 200 transmits a preamble towards the indicated candidate cell. To minimize data interruption of the source cell due to CFRA towards the candidate cell(s), the UE 200 does not receive a random access (RA) response from the NW for the purpose of TA value acquisition, and the TA value of the candidate cell(s) is indicated in the CSC. The UE 200 does not maintain the TA timer for the candidate cell, and relies on NW implementation to guarantee the TA validity.

At 218, the UE 200 performs Layer 1 (L1) measurements on the configured candidate cell(s), and transmits L1 measurement reports to the gNB 202. In this example, the L1 measurements may be performed if RRC reconfiguration is applicable. At 220, the gNB 202 makes a LTM decision to execute a cell switch to a target cell. At 222, after gNB's 202 decision, the gNB 202 transmits a CSC via MAC CE to the UE 200, and triggers cell switch by including a candidate configuration index of the target cell. At 224, the UE 200 detaches from the source cell, and switches to the target cell and applies the target cell configuration indicated by the candidate configuration index.

At 226, the UE 200 performs the RA procedure towards the target cell. At 228, the UE 200 completes the LTM cell switch procedure by sending a RRCReconfigurationComplete message to the target cell. For a random access channel (RACH) based LTM, if the UE has performed a RA procedure at 226, the UE considers that the LTM cell switch execution is successfully completed when the RA procedure is successfully completed. For RACH-less LTM, the UE 200 considers that LTM cell switch execution is successfully completed when the UE 200 determines that the NW has successfully received its first UL data.

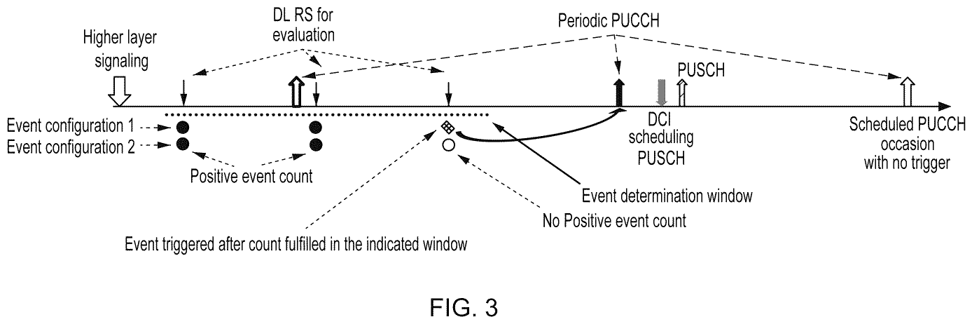

FIG. 3 illustrates an example UE initiated beam management (UEIBM) timeline. As illustrated in FIG. 3, the UEIBM may include a set of events configured to the UE for beam management monitoring. An event may be triggered, for example, when the L1 reference received power (RSRP) of the current serving beam is lower than a threshold, when under conditions such as for a consecutive amount of evaluations, and during a pre-defined time window. Once the event is triggered, the UE informs the gNB of the event by transmitting a 1-bit physical uplink control channel (PUCCH) signaling to the gNB. In one implementation, the gNB may schedule physical uplink shared channel (PUSCH) transmissions so that the UEIBM report is transmitted.

LTM may include a variety of events, and several such events involve the comparison of serving/candidate beam quality to fixed, yet configurable, thresholds, while in other events, the quality of the serving beam is compared to the quality of the candidate beam. For example, in event LTM3, the beam of the candidate cell may have an offset that is better than the beam of the serving cell. The difference between the beams of the candidate cell and the serving cell may govern the cell switch. When this event occurs, the cell CSC can be activated from the radio perspective. As such, event LTM3 can ensure basic functionality for advanced LTM operations.

In an event LTM2, the beam of the serving cell becomes worse than an absolute threshold, where if the measured quantity of the serving cell (for example the serving reference signal) compared to such absolute threshold is L1-RSRP, then the absolute threshold is a typical L1-RSRP value which may be used to decide if the quality of the measured quantity of the serving cell is lower or greater. This event does not give a direct indication to a CSC activation, but rather hints that in the serving cell, some action needs to be taken (e.g., preparation of LTM configuration in some cases). The action may be complemented with a UEIBM event 2, where the serving beam is compared to other candidate beams in the same cell would lead to a beam change in the serving cell. Thus, event LTM2 may be complemented with UEIBM event 2, and may ensure beam change in the serving cell. Event LTM2 is also identical to UEIBM event 1.

In an event LTM4, a beam of the candidate cell becomes better than an absolute threshold, as in event LTM2. Event LTM4 is concerned with handling the candidate cell beams, but does not imply a CSC command. Instead, event LTM4 is concerned with sorting the quality of candidate beams which may trigger early synchronization procedures including, for example, early TA acquisition or early candidate TCI state activation for the reported candidate beams/cells. Thus, event LTM4 sorts the candidate beam quality, which may be used to select candidate beams for early synchronization procedure. UEIBM event 2 may also ensure the selection of the best beams in the candidate cell.

In an event LTM5, a beam of the serving cell becomes worse than an absolute threshold1, and a beam of the candidate cell becomes better than another absolute threshold2. Event LTM5 is similar to event LTM3, allowing more flexible configurability, but achieving the similar functionality and governing the CSC activation. However, event LTM5 ensures more advanced functionality compared to event LTM3.

The L3 mobility event may also include RRC level mobility measurement reporting events. Examples of RRC level mobility measurement reporting events may include, for example, event A1 where the serving cell quality, measured by the RSRP of a measured reference signal from the serving cell, becomes better than an RSRP threshold, where the threshold is an RSRP value which, when compared to the RSRP of the measured reference signal, would allow the decision that the RSRP of the measured reference signal is greater of smaller. Another example of the RRC level mobility measurement reporting event may include event A2 where the RSRP of the serving cell becomes worse than an RSRP threshold. A further example of the RRC level mobility measurement reporting event may include event A3 where the RSRP of the neighbor cell becomes offset better than the RSRP of the measured reference signal from the PCell. Another example of the RRC level mobility measurement reporting may include event A4 where the RSRP of the measured reference signal from the neighbor cell becomes better than a threshold. In a further example, the RRC level mobility measurement reporting event may include event A5 where the RSRP of the reference signal from a PCell becomes worse than RSRP threhsold1 and the RSRP of the reference signal from the neighbor cell becomes better than RSRP threshold2.

The LTM events along the UEIBM events may govern the best beam availability at the UE. However, this is not sufficient to ensure CSI procedures (or CSI acquisition procedures). One way to handle CSI configurations is that once the UE receives the CSC, the UE may determine and report CSI for the new cell, while the former cell (if configured as LTM candidate) may become part of the list of target candidate cells the UE is requiring to further monitor. However, treating the former cell in this manner is not efficient.

For example, a ping-pong effect is created when the former cell becomes part of the list of target candidate cells. The ping-pong effect describes a situation in which the UE switches back and forth between the same two cells, especially when the cell switch decisions are made based on the L1 measurements (e.g., which typically do not use any filtering such as, for example, averaging of “measurements” over multiple time sample as done for L3 based measurements).

Treating the former UE to become part of the list of target candidate cells can also result in the UE having synchronization to the former cell, something not any other candidate cell may have. Treating the former UE to become part of the list of target candidate cells may also result in the UE just ending a set of CSI reports in an effective way as it was developing and refining that CSI feedback in the former cell. For the above reasons, certain example embodiments may provide further CSI feedback related procedures that can provide more efficient CSI computation and reporting in cell switch scenarios. Certain example embodiments may also provide improved ways to consider the CSI components for candidate cells by providing a UE-initiated based event that more efficiently controls the feedback computation and reporting overhead.

Certain example embodiments may provide an event tailored for efficient early CSI feedback handling. For instance, while a CSI report status indication indicates the status of the CSI measurement report associated with the CSI reporting to the cell (or the target cell), the status indication may include the information regarding the CSI computation for the previous serving cell and its status, if the previous serving cell is still being computed or if the previous serving cell is dropped.

The LTM/L3 mobility CSI event procedures in certain example embodiments may include the UE determining the CSI of a serving cell and a candidate cell. Once the CSI is determined for the serving and candidate cells, the UE may receive a CSC, which implicitly activates a monitoring window of a UEI CSI event evaluation. During the monitoring window, CSI metrics of the former serving cell may be compared with CSI metrics of the candidate tell (e.g., target cell). When the CSI metrics of the former serving cell becomes worse than the CSI metrics of the candidate cell, e.g., L1-RSRP of the former serving cell being lower than L1-RSRP of the candidate cell, which would result in the throughput achieved by the former serving cell becoming smaller than the throughput of the candidate cell, the LTM CSI event may be triggered.

In certain example embodiments, after the LTM CSI event is triggered, the UE drops the CSI computations of the former cell (e.g., serving cell). In other example embodiments, after the LTM CSI event is triggered, the UE may continue to monitor CQI, or other CSI metrics such as rank, PMI, various channel correlation coefficients, of the previous serving cell to determine whether to switch (e.g., implicitly) to evaluation of one of the LTM3, LTM4, or LTM5 events (or RRC level events such as A3, A4, etc.). In further example embodiments, after the LTM CSI event is triggered, the UE may continue to monitor CQI, or other CSI metrics such as rank, PMI, various channel correlation coefficients, of the previous serving cell for a duration of a timer or until the CQI, or other CSI metrics such as rank, PMI, various channel correlation coefficients, drop below a certain value. The CSI may then be determined in case the UE is switched back to the previous serving cell. In certain example embodiments, L3 mobility event (e.g., RRC level mobility) may be applied instead of LTM CSI event. Certain example embodiments may provide definition details for the CSI event. For instance, in some example embodiments, the CSI of the new serving cell (e.g., target cell) may be compared with the CSI of the former serving cell (e.g., source cell).

According to certain example embodiments, the CSI metrics of the new serving cell may need to be at least equal to or better than the CSI metrics of the former serving cell, or the serving cell specific conditions may be fulfilled for an event to be triggered. According to some example embodiments, the event may be triggered based on the satisfaction of one or more triggering conditions.

In certain example embodiments, one triggering condition may include when the CQI of the former serving cell is less than the CQI of the new serving cell, which results in a recordation by the UE of an event hit. The CQI comparison between the former serving cell and the new serving cell may be performed for the same radio channel rank, but the CQI may use a different PMI assumption in the computation. In another example embodiment, both CQIs of the former serving cell and the new serving cell and radio channel rank indicator values may be used for the comparison. For example, when the CQI of the former serving cell is less than the CQI of the new serving cell, and the rank of the former serving cell is less than the rank of the new serving cell, one event hit is recorded by the UE.

In other example embodiments, the triggering condition may include an offset value. For instance, when the CQI of the former serving cell plus the offset CQI value is less than the CQI of the new serving cell, one event hit is recorded by the UE, where the offset CQI is a indicated by the network or stored in the memory of the UE, and the offset CQI value may be, for example, a scalar in the range [0, 15].

According to certain example embodiments, the trigger condition may also include the CQI value of the former serving cell dropping below an absolute CQI value defined in various scenarios. For example, the absolute CQI value may be a CQI value reported by the UE before the reception of the CSC, a CQI value acquired by the UE before the reception of the CSC, a CQI value configured by the network, or a CQI value indicated by the network (e.g., in the CSC).

In certain example embodiments, for a single event hit or an amount of N above defined event hits recorded for consecutive evaluations or during a defined monitoring window, the event may be considered as triggered or the defined event criteria may be considered fulfilled for the duration of a monitoring window or duration. In these examples, the monitoring window/duration may be configured by the NW.

According to certain example embodiments, once the event is triggered or the defined event criteria is fulfilled, the UE may release the CSI processing units (CPUs) allocated to the computation of the former serving cell's CSI. According to certain example embodiments, UE may signal the release of the CPUs to the gNB explicitly or implicitly. For instance, in an implicit indication, the UE may signal the event trigger which equivalates with the stop of CSI calculations. In an explicit indication, the UE may signal the event trigger and explicitly indicate that the CSI computation for the former serving cell is stopped. However, even though the CSI computation may be stopped, the UE may continue to evaluate the LTM event for beam quality evaluation (e.g., LTM3, LTM4, LTM5 events) based on the LTM configuration in the new serving cell. According to other example embodiments, the UE may continue to monitor L3 mobility events (e.g., event A3, where the candidate cell becomes offset better than the serving cell). In some example embodiments, the event trigger or event trigger and additional explicit indication may be sent to the new serving cell along with a measurement report (in UCI or MAC CE).

In certain example embodiments, the UE may be configured to report the CSI computed for the old serving cell. For instance, in certain example embodiments, the UE may report the CSI of the old serving cell to the new serving cell, and the new serving cell may then forward the report to the old serving cell. In other embodiments, when the UE switches back to the old serving cell from the new serving cell, the UE may be configured to report the CSI measurement directly to the old serving cell. For example, the CSI for the old serving cell may be reported in the first PUSCH, or the UE may be requested to report the CSI measurement via downlink control information (DCI). In further example embodiments, the computed CSI may be reported indicating whether the CSI was computed based on a reporting configuration provided in the serving cell configuration or in the LTM configuration.

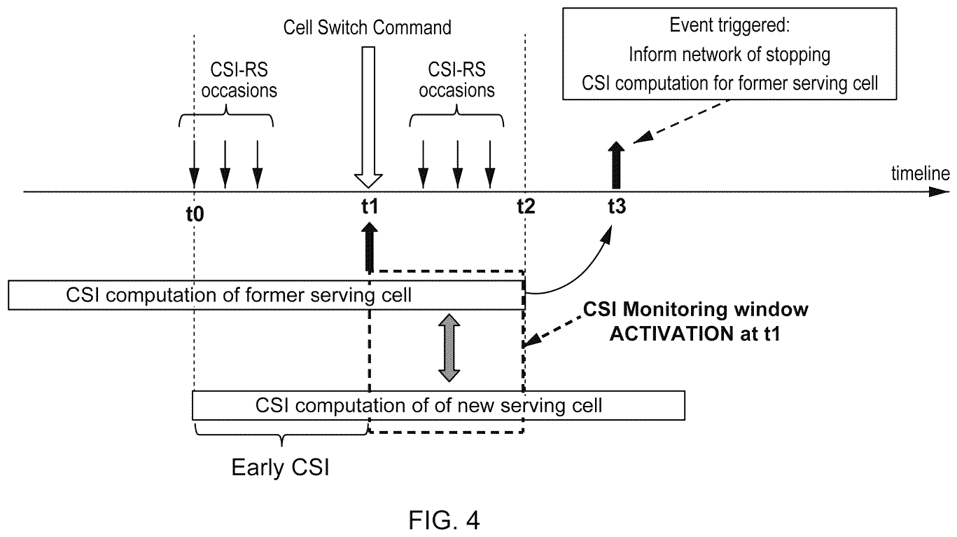

FIG. 4 illustrates an example LTM CSI event timeline, according to certain example embodiments. As illustrated in FIG. 4, the UE behavior may be defined during a CSI monitoring window and after the CSI monitoring window (e.g., between the time instances t1, t2, and after t2). At t0 in FIG. 4, the UE determines CSI for the former serving cell (before the CSC is received). Thus, at t0, the UE evaluates the provided CSI-RS occasions or SSBs, or any other reference signals involved in the CSI computation. For example, DM-RS may be used by the UE for some forms of CQI computation(s).

As also illustrated in FIG. 4, at t0, the UE determines early CSI for the candidate cell (which after the CSC is called new serving cell). According to certain example embodiments, the UE can determine early CSI because of the UE's support for early CSI for candidate cell(s) before the reception of the CSC. Furthermore, at t0, the UE may evaluate some type of event including, for example, LTM, UEIBM, UEI-CSI, or other UEI events. At t0, the UE may allocate CPU(s) dedicated to the determination of such early CSI feedback.

At t1, the UE receives the CSC command, which implicitly activates the CSI monitoring window or initiates a counting operation. As illustrated in FIG. 4, the CSI monitoring window is designated between t2-t1, during which the CSI of the former serving cell and the CSI of the new serving cell are evaluated as part of an LTM/L3 mobility CSI event. At t2, the event is triggered or the defined event criteria is fulfilled. Once the event is triggered or the defined event criteria is fulfilled, the UE stops the CSI determination and measurements of the former serving cell, and the UE releases the CPU(s) that was allocated to the CSI determination or the former serving cell.

If an event counting operation is initiated, each time when the CSI of the new serving cell is better than the CSI of the former serving cell, it is considered an evaluation hit which increments the event counter with one. When the event counter is reaching a predefined value, the event is considered triggered.

At t2, the UE may also implicitly start evaluating the LTM/L3 mobility/UEIBM event for the former serving cell (e.g., in case there is potential for the UE to return to the former serving cell), and the UE may be configured by the NW not to start any other event monitoring for the former serving cell. According to certain example embodiments, the time interval t3−t2 may be equal to zero, one or more symbols, depending on the UE capability and/or on the channel over which the trigger indication occurs at t3. At t3, the trigger information may be signaled to the NW, and the trigger information may be signaled to the network via UCI of PUCCH, MAC-CE, or physical random access channel (PRACH).

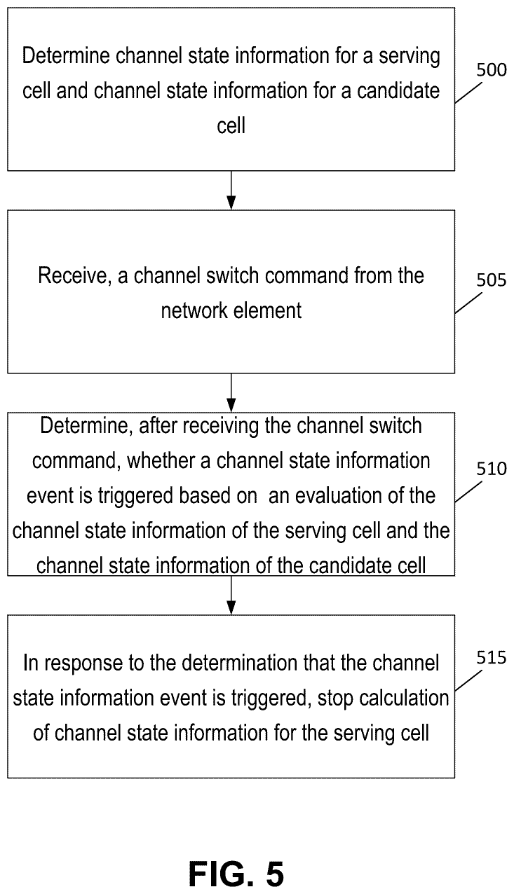

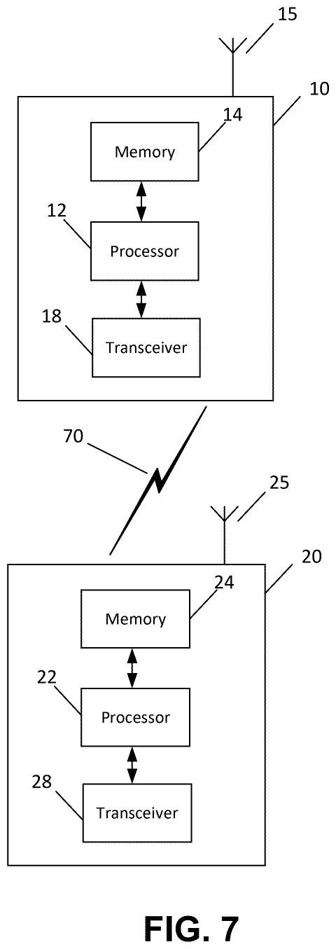

FIG. 5 illustrates an example flow diagram of a method, according to certain example embodiments. In an example embodiment, the method of FIG. 5 may be performed by a network entity, or a group of multiple network elements in a 3GPP system, such as LTE or 5G-NR. For instance, in an example embodiment, the method of FIG. 5 may be performed by a UE, similar to apparatus 10 illustrated in FIG. 7.

As illustrated in FIG. 5, the method may include, at 500, determining channel state information for a serving cell and channel state information for a candidate cell. The method may also include, at 505, receiving, a channel switch command from the network element. The method may further include, at 510, determining, after receiving the channel switch command, whether a channel state information event is triggered based on an evaluation of the channel state information of the serving cell and the channel state information of the candidate cell. In addition, the method may include, at 515, in response to the determination that the channel state information event is triggered, stopping calculation of channel state information for the serving cell.

According to certain example embodiments, the method may also include transmitting, to the candidate cell, a report comprising the channel state information for the serving cell and the channel state information for the candidate cell. According to some example embodiments, the report may include an indication of whether the channel state information of the serving cell or the channel state information of the candidate cell is determined based on a reporting configuration provided in a serving cell configuration or in a layer 1/2-triggered mobility configuration. According to other example embodiments, the channel state information for the candidate cell may be determined prior to receiving the channel switch command.

In certain example embodiments, receipt of the channel switch command may implicitly activate a channel state information event monitoring window or initiates a counting operation. In some example embodiments, the determining may include comparing, during the channel state information monitoring window, or until the counting operation reaches a predefined counting value, the channel state information of the serving cell with the channel state information of the candidate cell.

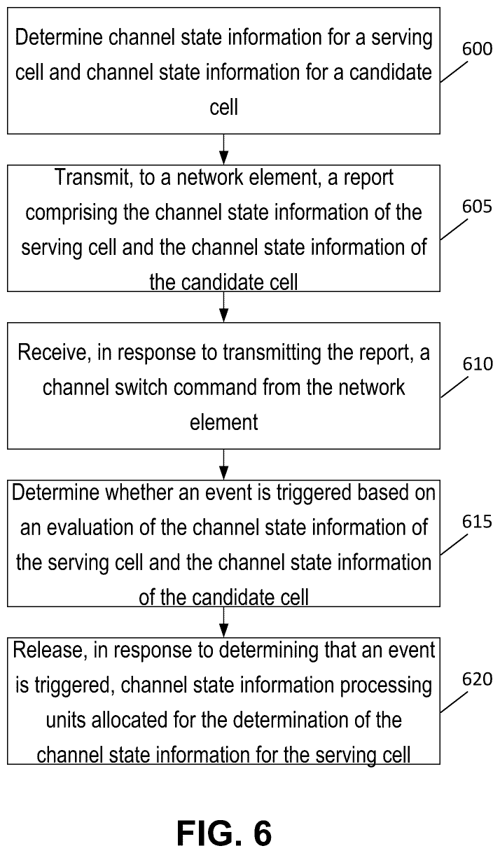

FIG. 6 illustrates an example flow diagram of another method, according to certain example embodiments. In an example embodiment, the method of FIG. 6 may be performed by a network entity, or a group of multiple network elements in a 3GPP system, such as LTE or 5G-NR. For instance, in an example embodiment, the method of FIG. 6 may be performed by a UE, similar to apparatus 10 illustrated in FIG. 7.

As illustrated in FIG. 6, the method may include, at 600, determining channel state information for a serving cell and channel state information for a candidate cell. The method may also include, at 605, transmitting, to a network element, a report comprising the channel state information of the serving cell and the channel state information of the candidate cell. The method may further include, at 610, receiving, in response to transmitting the report, a channel switch command from the network element. In addition, the method may include, at 615, determining whether an event is triggered based on an evaluation of the channel state information of the serving cell and the channel state information of the candidate cell. Further, the method may include, at 620, releasing, in response to determining that an event is triggered, channel state information processing units allocated for the determination of the channel state information for the serving cell.

According to certain embodiments, the method may also include notifying the network element either implicitly or explicitly that the channel state information processing units have been released. According to some example embodiments, the implicit notification of the network element may include signaling to the network element the triggering condition for the event that equivalates with a stop in channel state information calculations. According to other example embodiments, the explicit notification of the network element may include signaling to the network element the triggering condition for the event that channel state information determination for the serving cell is stopped, but event evaluation for beam quality evaluation is continued.

In certain example embodiments, the network element may be notified implicitly or explicitly that the channel state information processing units have been released via an uplink control information, or a medium access control, control element. In some example embodiments, the channel state information for the candidate cell may be determined prior to receiving the channel switch command. In other example embodiments, receipt of the channel switch command implicitly activates a channel state information event monitoring window or initiates a counting operation.

According to certain example embodiments, determining whether the event is triggered may include comparing, during the channel state information monitoring window, or until the counting operation reaches a predefined counting value, the channel state information of the serving cell with the channel state information of the candidate cell. According to some example embodiments, the event may be triggered in response to at least one of the following conditions being satisfied: the channel state information of the serving cell is less than the channel state information of the candidate cell, the combined channel state information of the serving cell and an offset channel state information value is less than the channel state information of the candidate cell, or the channel state information of the serving cell is less than a channel state information value that a user equipment reported before reception of the channel switch command, or acquired before reception of the channel switch command.

FIG. 7 illustrates a set of apparatuses 10 and 20 according to certain example embodiments. In certain example embodiments, apparatuses 10 and 20 may be elements in a communications network or associated with such a network. For example, apparatus 10 may be a UE, or other similar radio communication computer device, and apparatus 20 may be a BS, gNB, network, or other similar computing device.

In some example embodiments, apparatuses 10 and 20 may include one or more processors, one or more computer-readable storage medium (for example, memory, storage, or the like), one or more radio access components (for example, a modem, a transceiver, or the like), and/or a user interface. In some example embodiments, apparatuses 10 and 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatuses 10 and 20 may include components or features not shown in FIG. 7.

As illustrated in the example of FIG. 7, apparatuses 10 and 20 may include or be coupled to a processor 12 and 22 for processing information and executing instructions or operations. Processors 12 and 22 may be any type of general or specific purpose processor. In fact, processors 12 and 22 may include one or more of general-purpose computers, special purpose computers, microprocessors, DSPs, field-programmable gate arrays (FPGAs), application-specific integrated circuits (ASICs), and processors based on a multi-core processor architecture, as examples. While a single processor 12 and 22 is shown in FIG. 7, multiple processors may be utilized according to other example embodiments. For example, it should be understood that, in certain example embodiments, apparatuses 10 and 20 may include two or more processors that may form a multiprocessor system (e.g., in this case processors 12 and 22 may represent a multiprocessor) that may support multiprocessing. According to certain example embodiments, the multiprocessor system may be tightly coupled or loosely coupled (e.g., to form a computer cluster).

Processors 12 and 22 may perform functions associated with the operation of apparatuses 10 and 20 including, as some examples, precoding of antenna gain/phase parameters, encoding and decoding of individual bits forming a communication message, formatting of information, and overall control of the apparatuses 10 and 20, including processes and examples illustrated in FIGS. 1-6.

Apparatuses 10 and 20 may further include or be coupled to a memories 14 and 24 (internal or external), which may be respectively coupled to processors 12 and 22 for storing information and instructions that may be executed by processors 12 and 22. Memories 14 and 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memories 14 and 24 can be comprised of any combination of random access memory (RAM), read only memory (ROM), static storage such as a magnetic or optical disk, hard disk drive (HDD), or any other type of non-transitory machine or computer readable media. The instructions stored in memories 14 and 24 may include program instructions or computer program code that, when executed by processors 12 and 22, enable the apparatuses 10 and 20 to perform tasks as described herein.

In certain example embodiments, apparatuses 10 and 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 12 and 22 and/or apparatuses 10 and 20 to perform any of the methods and examples illustrated in FIGS. 1-6.

In some example embodiments, apparatuses 10 and 20 may also include or be coupled to one or more antennas 15 and 25 for receiving a downlink signal and for transmitting via an UL from apparatuses 10 and 20. Apparatuses 10 and 20 may further include a transceivers 18 and 28 configured to transmit and receive information. The transceivers 18 and 28 may also include a radio interface (e.g., a modem) coupled to the antennas 15 and 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceivers 18 and 28 may be configured to modulate information on to a carrier waveform for transmission by the antennas 15 and 25 and demodulate information received via the antenna 15 and 25 for further processing by other elements of apparatuses 10 and 20. In other example embodiments, transceivers 18 and 28 may be capable of transmitting and receiving signals or data directly. Additionally or alternatively, in some example embodiments, apparatus 10 may include an input and/or output device (I/O device). In certain example embodiments, apparatuses 10 and 20 may further include a user interface, such as a graphical user interface or touchscreen.

In certain example embodiments, memories 14 and 24 store software modules that provide functionality when executed by processors 12 and 22. The modules may include, for example, an operating system that provides operating system functionality for apparatuses 10 and 20. The memory may also store one or more functional modules, such as an application or program, to provide additional functionality for apparatuses 10 and 20. The components of apparatuses 10 and 20 may be implemented in hardware, or as any suitable combination of hardware and software. According to certain example embodiments, apparatuses 10 and 20 may optionally be configured to communicate each other (in any combination) via a wireless or wired communication links 70 according to any radio access technology, such as NR.

According to certain example embodiments, processors 12 and 22 and memories 14 and 24 may be included in or may form a part of processing circuitry or control circuitry. In addition, in some example embodiments, transceivers 18 and 28 may be included in or may form a part of transceiving circuitry.

For instance, in certain example embodiments, apparatus 10 may be controlled by memory 14 and processor 12 to determine channel state information for a serving cell and channel state information for a candidate cell. Apparatus 10 may also be controlled by memory 24 and processor 12 to receive, a channel switch command from the network element. Apparatus 10 may further be controlled by memory 14 and processor 12 to determine, after receiving the channel switch command, whether a channel state information event is triggered based on an evaluation of the channel state information of the serving cell and the channel state information of the candidate cell. In addition, apparatus 10 may be controlled by memory 14 and processor 12 to, in response to the determination that the channel state information event is triggered, stop calculation of channel state information for the serving cell.

In other example embodiments, apparatus 10 may be controlled by memory 14 and processor 12 to determine channel state information for a serving cell and channel state information for a candidate cell. Apparatus 10 may also be controlled by memory 14 and processor 12 to transmit, to a network element, a report comprising the channel state information of the serving cell and the channel state information of the candidate cell. Apparatus 10 may further be controlled by memory 14 and processor 12 to receive, in response to transmitting the report, a channel switch command from the network element. In addition, apparatus 10 may be controlled by memory 14 and processor 12 to determine whether an event is triggered based on an evaluation of the channel state information of the serving cell and the channel state information of the candidate cell. Further, apparatus 10 may be controlled by memory 14 and processor 12 to release, in response to determining that an event is triggered, channel state information processing units allocated for the determination of the channel state information for the serving cell.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for determining channel state information for a serving cell and channel state information for a candidate cell. The apparatus may also include means for receiving, a channel switch command from the network element. The apparatus may further include means for determining, after receiving the channel switch command, whether a channel state information event is triggered based on an evaluation of the channel state information of the serving cell and the channel state information of the candidate cell. In addition, the apparatus may include, in response to the determination that the channel state information event is triggered, means for stopping calculation of channel state information for the serving cell.

Other example embodiments may be directed to an apparatus that includes means for determining channel state information for a serving cell and channel state information for a candidate cell. The apparatus may also include means for transmitting, to a network element, a report comprising the channel state information of the serving cell and the channel state information of the candidate cell. The apparatus may further include means for receiving, in response to transmitting the report, a channel switch command from the network element. In addition, the apparatus may include means for determining whether an event is triggered based on an evaluation of the channel state information of the serving cell and the channel state information of the candidate cell. Further, the apparatus may include means for releasing, in response to determining that an event is triggered, channel state information processing units allocated for the determination of the channel state information for the serving cell.

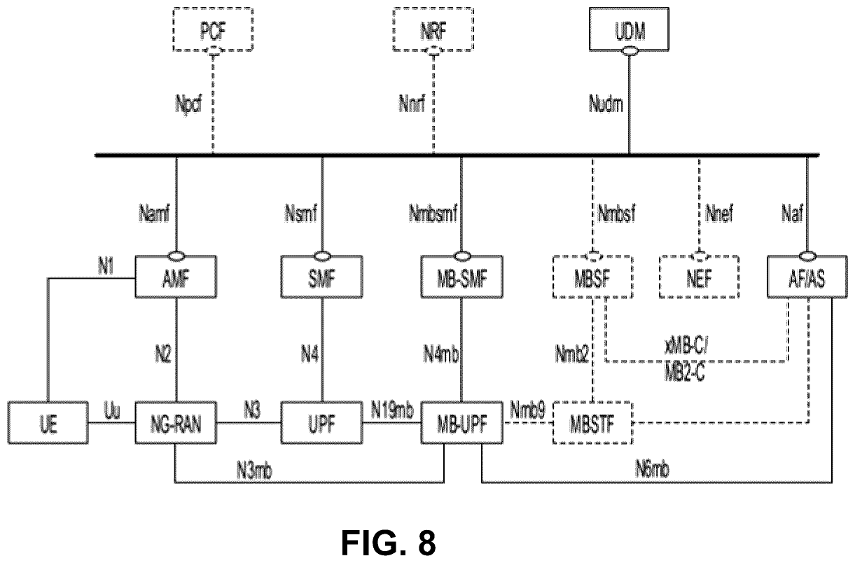

FIG. 8 illustrates an example of a 5G/6G network and system architecture, according to certain example embodiments. Shown are multiple network functions that may be implemented as software operating as part of a network device or dedicated hardware, as a network device itself or dedicated hardware, or as a virtual function operating as a network device or dedicated hardware. The UE illustrated in FIG. 8 may be similar to UE 10. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

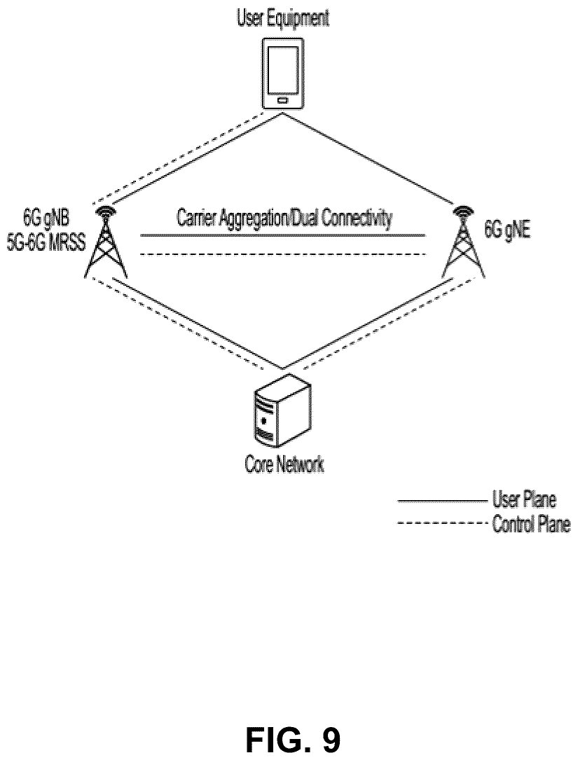

FIG. 9 illustrates an example 6G architecture, according to certain example embodiments. In particular, the 6G architecture in FIG. 9 may support LCM configured to natively support AI/ML, cloud-native functionalities. Additionally, 6G gNBs may be configured to support multi-RAT spectrum sharing (MRSS).

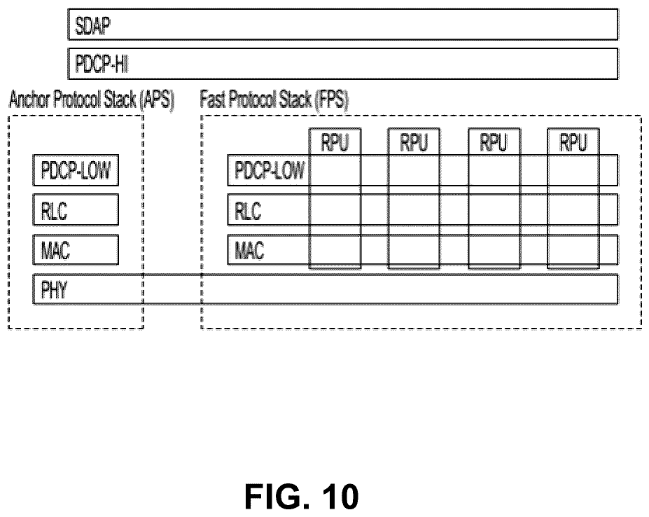

FIG. 10 illustrates an example 6G RAN protocol stack, according to certain example embodiments. The 6G RAN protocol stack may share some similarities with a 5G RAN protocol stack. For example, the depicted 6G RAN protocol stack may incorporate service data application protocol (SDAP), packet data convergence protocol (PDCP), radio link control (RLC), and medium access control (MAC) functions, which may interface with multiple radio protocol units (RPUs).

Certain example embodiments described herein provide several technical improvements, enhancements, and/or advantages. For instance, in some example embodiments, it may be possible to provide further CSI feedback related procedures that provide more efficient CSI computation and reporting in cases of cell switch. In other example embodiments, it may be possible to provide improved considerations of CSI components for candidate cells by introducing a UE-initiated based event that more efficiently controls the feedback determination and reporting overhead.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### Partial Glossary

3GPP 3rd Generation Partnership Project
5G 5th Generation
5GC 5G Core
5GCN 5G Core Network
BS Base Station
BM Beam Management
CSI Channel State Information
CSI-RS Channel State Information Reference Signal
CPU CSI Processing Unit
DCI Downlink Control Information
DL Downlink
eNB Enhanced Node B
E-UTRAN Evolved UTRAN
gNB 5G or Next Generation NodeB
HO Handover
L1 Layer 1
L2 Layer 2
L3 Layer 3
L3 Mobility RRC Level Mobility
LTM L1/2-triggered Mobility
MAC Medium Access Control
MAC CE MAC Control Element
PDSCH Physical Downlink Shared Channel
MIMO Multiple Input Multiple Output
PHY Physical Layer
RRC Radio Resource Control
RS Reference Signal
RSRP Reference Signal Received Power
SP Semi-Persistent
SRS Sounding Reference Signal
SSB Synchronization Signal Block
UE User Equipment
UL Uplink

1. An apparatus, comprising:
at least one processor; and
at least one memory storing instructions which, when executed by the at least one processor, cause the apparatus to at least:
determine channel state information for a serving cell and channel state information for a candidate cell;
transmit, to a network element, a report comprising the channel state information of the serving cell and the channel state information of the candidate cell;
receive, in response to transmitting the report, a channel switch command from the network element;
determine whether an event is triggered based on an evaluation of the channel state information of the serving cell and the channel state information of the candidate cell; and
release, in response to determining that an event is triggered, channel state information processing units allocated for the determination of the channel state information for the serving cell.

2. The apparatus according to claim 1, wherein the instructions, when executed by the at least one processor, further cause the apparatus to:
notify the network element either implicitly or explicitly that the channel state information processing units have been released.

3. The apparatus according to claim 2, wherein the implicit notification of the network element comprises signaling to the network element the triggering condition for the event that equivalates with a stop in channel state information calculations.

4. The apparatus according to claim 2, wherein the explicit notification of the network element comprises signaling to the network element the triggering condition for the event that channel state information determination for the serving cell is stopped, but event evaluation for beam quality evaluation is continued.

5. The apparatus according to claim 2, wherein the network element is notified implicitly or explicitly that the channel state information processing units have been released via an uplink control information, or a medium access control, control element.

6. The apparatus according to claim 1, wherein the channel state information for the candidate cell is determined prior to receiving the channel switch command.

7. The apparatus according to claim 1, wherein receipt of the channel switch command implicitly activates a channel state information event monitoring window or initiates a counting operation.

8. The apparatus according to claim 7, wherein determining whether the event is triggered comprises:
comparing, during the channel state information monitoring window, or until the counting operation reaches a predefined counting value, the channel state information of the serving cell with the channel state information of the candidate cell.

9. The apparatus according to claim 8, wherein the event is triggered in response to at least one of the following conditions being satisfied:
the channel state information of the serving cell is less than the channel state information of the candidate cell,
the combined channel state information of the serving cell and an offset channel state information value is less than the channel state information of the candidate cell, or
the channel state information of the serving cell is less than a channel state information value that the apparatus
reported before reception of the channel switch command, or
acquired before reception of the channel switch command.

10-18. (canceled)

19. A method, comprising:
determining channel state information for a serving cell and channel state information for a candidate cell;
transmitting, to a network element, a report comprising the channel state information of the serving cell and the channel state information of the candidate cell;
receiving, in response to transmitting the report, a channel switch command from the network element;
determining whether an event is triggered based on an evaluation of the channel state information of the serving cell and the channel state information of the candidate cell; and
releasing, in response to determining that an event is triggered, channel state information processing units allocated for the determination of the channel state information for the serving cell.

20. The method according to claim 19, further comprising:
notifying the network element either implicitly or explicitly that the channel state information processing units have been released.

21. The method according to claim 20, wherein the implicit notification of the network element comprises signaling to the network element the triggering condition for the event that equivalates with a stop in channel state information calculations.

22. The method according to claim 20, wherein the explicit notification of the network element comprises signaling to the network element the triggering condition for the event that channel state information determination for the serving cell is stopped, but event evaluation for beam quality evaluation is continued.

23. The method according to claim 20, wherein the network element is notified implicitly or explicitly that the channel state information processing units have been released via an uplink control information, or a medium access control, control element.

24. The method according to claim 19, wherein the channel state information for the candidate cell is determined prior to receiving the channel switch command.

25. The method according to claim 19, wherein receipt of the channel switch command implicitly activates a channel state information event monitoring window or initiates a counting operation.

26. The method according to claim 25, wherein determining whether the event is triggered comprises:
comparing, during the channel state information monitoring window, or until the counting operation reaches a predefined counting value, the channel state information of the serving cell with the channel state information of the candidate cell.

27. The method according to claim 26, wherein the event is triggered in response to at least one of the following conditions being satisfied:
the channel state information of the serving cell is less than the channel state information of the candidate cell,
the combined channel state information of the serving cell and an offset channel state information value is less than the channel state information of the candidate cell, or
the channel state information of the serving cell is less than a channel state information value that a user equipment
reported before reception of the channel switch command, or
acquired before reception of the channel switch command.

28. (canceled)

29. (canceled)

30. A non-transitory computer readable medium encoded with instructions that, when executed in hardware, perform a process, the process comprising:
determining channel state information for a serving cell and channel state information for a candidate cell;
transmitting, to a network element, a report comprising the channel state information of the serving cell and the channel state information of the candidate cell;
receiving, in response to transmitting the report, a channel switch command from the network element;
determining whether an event is triggered based on an evaluation of the channel state information of the serving cell and the channel state information of the candidate cell; and
releasing, in response to determining that an event is triggered, channel state information processing units allocated for the determination of the channel state information for the serving cell.
